(19) United States
(12) Patent Application Publication
(10) Pub. No.: US 2025/0049255 A1
(43) Pub. Date: Feb. 13, 2025

(54) DEVICE TO REMOVE A COFFEE PUCK

(71) Applicant: BREVILLE PTY LIMITED, Alexandria (AU)

(72) Inventors: Khon Minh Thai, Alexandria (AU); Duncan Bruce Hellmers, Alexandria (AU); Stephen John Mcclean, Alexandria (AU); Maaike Petronella Kleijn, Alexandria (AU); Chaoyu Bi, Alexandria (AU)

(73) Assignee: BREVILLE PTY LIMITED, Alexandria (AU)

(21) Appl. No.: 18/722,696

(22) PCT Filed: Dec. 23, 2022
(86) PCT No.: PCT/AU2022/051588

§ 371 Date: Jun. 21, 2024

(30) Foreign Application Priority Data
Dec. 24, 2021 (AU) 2021904277

(51) Int. Cl. A47J 31/60; A47J 31/06; B08B 5/04; B08B 9/08; F16J 15/10

(52) U.S. Cl. CPC A47J 31/60; A47J 31/0663; B08B 5/04; B08B 9/08; F16J 15/104; B08B 2209/08

(57) ABSTRACT

There is disclosed herein a device (100) compatible with more than one type of portafilter to remove a coffee puck contained within an open compartment of the respective portafilter (180, 182), the coffee puck having an exposed first major face and a second major face in contact with the compartment, the device including: a body (102) providing an interior space (108) and having a rim (118) surrounding an aperture of the space (108), with the rim (118) being configured to engage the respective portafilter such that the first major face of the coffee puck in the open compartment of the respective portafilter (180, 182) communicates with the aperture; a vacuum source (132) to create a pressure differential between the first major face and the second major face of the coffee puck; and a sealing member (158) to sealingly connect the respective portafilter (180, 182) and the rim (118) so that air pressure applied to the first major face is less than air pressure applied to the second major face of the coffee puck to remove the coffee puck from the respective portafilter (180, 182), wherein the sealing member (158) provides a sealing contact area, and wherein the sealing member (158) is configured to sealingly engage the respective portafilter (180, 182) at a predefined location on the sealing contact area based on the type of portafilter (180, 182).

### FIELD

The present relates to the cleaning of espresso machine portafilters, and more particularly a device for removing a coffee puck from an espresso machine portafilter.

### BACKGROUND

In a conventional espresso machine, a portafilter is used to carry coffee grounds during a coffee brewing process. After the coffee brewing process is complete, the used coffee grounds are removed from the portafilter so that fresh coffee grounds may be inserted for the next brew. The used coffee grounds are typically dense and compacted in the portafilter in the form of a coffee puck.

WO2020000045A1 discloses a device for removal of a coffee puck from a portafilter. The device includes a rim to engage the portafilter, and a vacuum source to create a suction force for removing the coffee puck from the portafilter. Disadvantageously, the device is only compatible with one type of portafilter. The user may also locate the portafilter in an undesired location where contact area between the portafilter and the device may result in an improper seal.

### OBJECT

It is an object of the present invention to substantially overcome, or at least ameliorate, the above disadvantage, or to provide a useful alternative thereto.

### SUMMARY

In one aspect, the invention provides a device compatible with more than one type of portafilter to remove a coffee puck contained within an open compartment of the respective portafilter, the coffee puck having an exposed first major face and a second major face in contact with the compartment, the device including:
a body providing an interior space and having a rim surrounding an aperture of the space, with the rim being configured to engage the respective portafilter such that the first major face of the coffee puck in the open compartment of the respective portafilter communicates with the aperture;
a vacuum source to create a pressure differential between the first major face and the second major face of the coffee puck; and
a sealing member to sealingly connect the respective portafilter and the rim so that air pressure applied to the first major face is less than air pressure applied to the second major face of the coffee puck to remove the coffee puck from the respective portafilter, wherein
the sealing member provides a sealing contact area, and wherein
the sealing member is configured to sealingly engage the respective portafilter at a predefined location on the sealing contact area based on the type of portafilter.

Preferably, the sealing member includes a disc-shaped base providing an upwardly facing sealing surface radially extending between an outer periphery and a circumferentially extending inner edge of the base.

Preferably, the inner edge surrounds an opening of the base, with the opening having a diameter substantially the same as or marginally smaller than a maximum width of the aperture.

Preferably, the sealing member includes a plurality of supporting wall segments projecting upwardly from the outer periphery of the base, with the plurality of supporting wall segments together with the sealing surface and the inner edge providing the sealing contact area.

In another aspect, the invention provides an adaptor for a device configured to remove a coffee puck contained within an open compartment of a portafilter, the device including a body providing an interior space and having a rim surrounding an aperture of the space, with a maximum width of the open compartment of the portafilter being less than a maximum width of the aperture, the adaptor including:
a lower surface to sealingly engage the rim; and
an upper surface having a width extending beyond the rim and partially over the aperture to sealingly engage the portafilter.

In yet another aspect, the invention provides an adaptor for a device configured to remove a coffee puck contained within an open compartment of a portafilter, the device including a body providing an interior space and having a rim surrounding an aperture of the space, with a maximum width of the open compartment of the portafilter being greater than a maximum width of the rim, the adaptor including:
a lower surface to sealingly engage the rim;
an upper surface to sealingly engage the portafilter; and
a height extending between the lower and upper surfaces to raise the upper surface above the body to space the portafilter from the body.

### BRIEF DESCRIPTION OF DRAWINGS

Exemplary embodiments of the present disclosure will now be described, by way of examples only, with reference to the accompanying description and drawings in which:

FIG. 1 is a perspective view of a coffee puck removal device according to one embodiment;

FIG. 2 is a perspective view of a sealing member of the device of FIG. 1;

FIG. 3 is an additional perspective view of the sealing member of the device of FIG. 1;

FIG. 4 is a top view of the device of FIG. 1, shown with a portafilter engaged with the device;

FIG. 5 is a vertically sectioned view taken along line A-A of FIG. 4;

FIG. 6 is a top view of the device of FIG. 1;

FIG. 7 is a vertically sectioned view taken along line B-B of FIG. 6;

FIG. 8 is a detail view of portion A of FIG. 7;

FIG. 9 is a vertically sectioned side view of the device of FIG. 1, shown with the portafilter engaged with a rim of the device;

FIG. 10 is a detail view of portion B of FIG. 9;

FIG. 11 is a vertically sectioned side view of the device of FIG. 1, shown with a different portafilter engaged with the rim of the device;

FIG. 12 is a detail view of portion C of FIG. 11;

FIG. 13 is a detail view of portion D of FIG. 11;

FIG. 14 is an additional perspective view of the device of FIG. 1, showing positioning of the sealing member on the rim of the device;

FIG. 15 is a vertically sectioned side view of a coffee puck removal device according to another embodiment, shown with a portafilter engaged with the rim of the device;

FIG. 16 is a detail view of portion E of FIG. 15;

FIG. 17 is a detail view of portion F of FIG. 15;

FIG. 18 is an additional perspective view of the device of FIG. 15, shown with a different portafilter engaged with the rim of the device;

FIG. 19 is a detail view of portion G of FIG. 18;

FIG. 20 is a simplified schematic detail view of a basket of a portafilter engaged with the sealing member of the device of FIG. 1 or FIG. 15;

FIG. 21 is a simplified schematic detail view of a different basket of a different portafilter engaged with the sealing member of the device of FIG. 1 or FIG. 9;

FIG. 22 is a parts exploded view of the sealing member of the device of FIG. 1 or FIG. 15 and an adaptor ring;

FIG. 23 is a simplified schematic detail view of a basket of a portafilter engaged with the adaptor ring of FIG. 22;

FIG. 24 is a simplified schematic detail view of the basket of the portafilter engaged with a modified embodiment of the adaptor ring of FIG. 22;

FIG. 25 is a parts exploded view of the sealing member of the device of FIG. 1 or FIG. 15 and a different adaptor ring;

FIG. 26 is a simplified schematic detail view of a different basket of a different portafilter engaged with the adaptor ring of FIG. 25;

FIG. 27 is a simplified schematic detail view of the basket of the portafilter engaged with a modified embodiment of the adaptor ring of FIG. 25;

FIG. 28 is a top view of a coffee puck removal device according to another embodiment;

FIG. 29 is a vertically sectioned view taken along line C-C of FIG. 28;

FIG. 30 is a detail view of portion H of FIG. 29;

FIG. 31 is an additional detail view of portion H of FIG. 29, shown with a portafilter engaged with a sealing member of the device;

FIG. 32 is a vertically sectioned side view of the device of FIG. 1, shown with the portafilter engaged with the modified embodiment of the adaptor ring of FIG. 25;

FIG. 33 is a detail view of portion I of FIG. 32;

FIG. 34 is a perspective view of a coffee puck removal device according to another embodiment, shown with a portafilter engaging the device in a cradle-like manner;

FIG. 35 is an additional perspective view of the device of FIG. 34, shown with the portafilter engaged with the device;

FIG. 36 is a perspective view of a coffee puck removal device according to another embodiment;

FIG. 37 is a detail view of portion J of FIG. 36;

FIG. 38 is a top view of the device of FIG. 36, shown with a portafilter engaging the device in a bayonet-like manner;

FIG. 39 is a top view of the device of FIG. 36, shown with the portafilter engaged with the device;

FIG. 40 is a perspective view of a coffee puck removal device according to another embodiment;

FIG. 41 is an additional perspective view of the device of FIG. 40, shown with a portafilter engaged with the device;

FIG. 42 is an additional perspective view of the device of FIG. 40, shown with the portafilter operating the device;

FIG. 43 is a vertically sectioned side view of the device of FIG. 41; and

FIG. 44 is a vertically sectioned side view of the device of FIG. 42.

### DESCRIPTION OF EMBODIMENTS

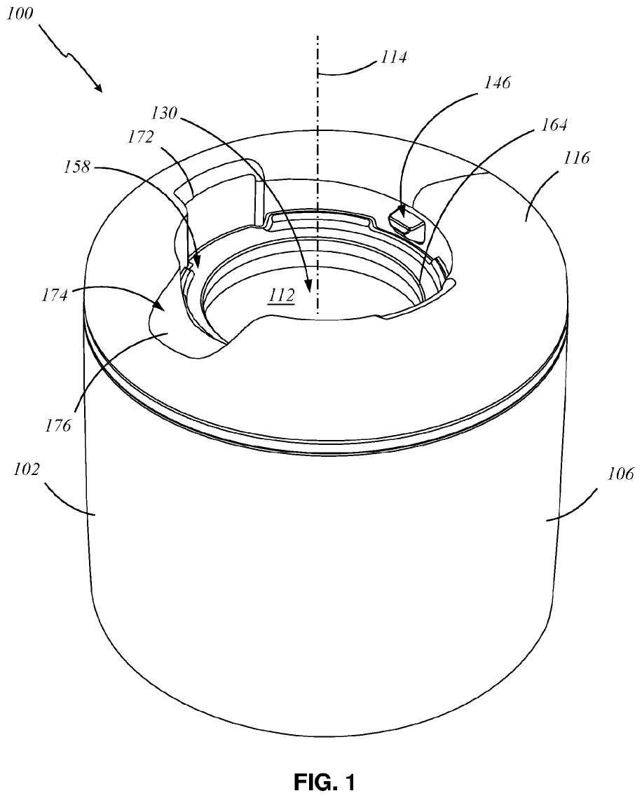

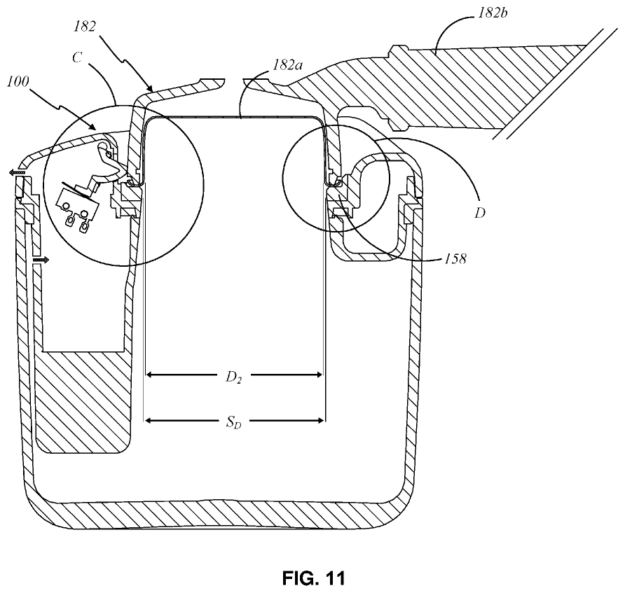

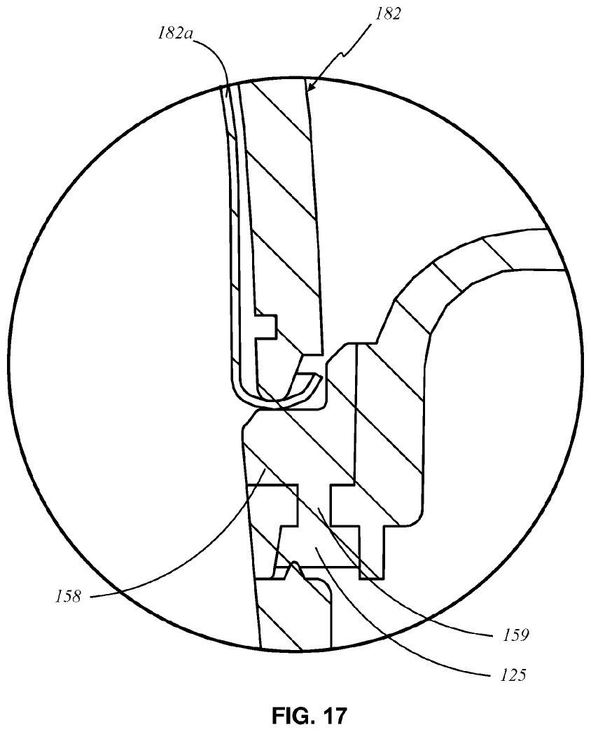

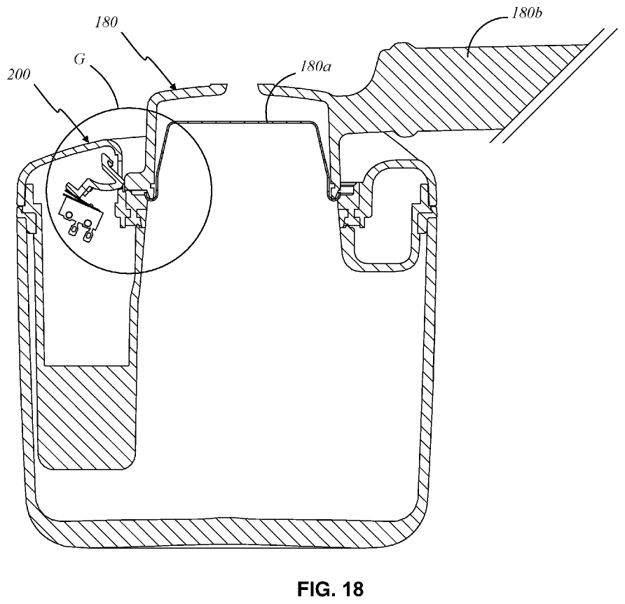

Referring firstly to FIG. 1 of the accompanying drawings, there is schematically depicted a device 100 to remove spent coffee grounds (hereinafter referred to as a “coffee puck”) from a portafilter 180, 182 (see FIGS. 11 and 18) of an espresso machine (not shown). It will be understood that the coffee puck is formed from compressed used coffee grounds following a coffee brewing process of the espresso machine. The coffee puck typically takes the shape of a circular basket 180a, 182a removably located within an open compartment of the portafilter 180, 182 and has an exposed first major face and a second major face in contact with the basket 180a, 182a.

The device 100 is configured to accommodate or be compatible with various types of portafilters for different types of espresso machines. For example, the portafilters may vary in one or more characteristics such as size of compartment or number and configuration of locking tabs. In some instances, a diameter of the compartment of the portafilter may be in a range of about 51 mm to 58 mm, the number of tabs of the portafilter may be two or three, and the tabs may be arranged transversely or obliquely relative to a handle of the portafilter.

With particular reference to FIG. 7, the device 100 includes a container body 102 providing a base 104 and a generally cylindrical upwardly extending sidewall 106 protruding from the base 104. The sidewall 106 and base 104 partially surround an interior space 108 of the body 102. The sidewall 106 terminates at an upper edge 110 thereof to define an open top 112 of the space 108. A central axis 114 of the body 102 extends perpendicularly between the base 104 and the open top 112.

The open top 112 is partially closed by a cover or lid 116 to be centred on the axis 114. The lid 116 is generally annular in configuration and provides an inner rim 118, an outer rim 120, and a ceiling portion 122 extending between the inner and outer rims 118, 120. The outer rim 120 is configured to engage the upper edge 110 of the sidewall 106 via a first resilient member 124, such as an elastomer, which aids in sealingly connecting the outer rim 120 of the lid 116 and the upper edge 110 of the sidewall 106. To further aid in sealing the outer rim 120 with the upper edge 110, the first resilient member 124 includes an overhang portion providing a vertical sealing face 124a for sealing engagement with an inner, upper surface of the sidewall 106 adjacent the upper edge 110.

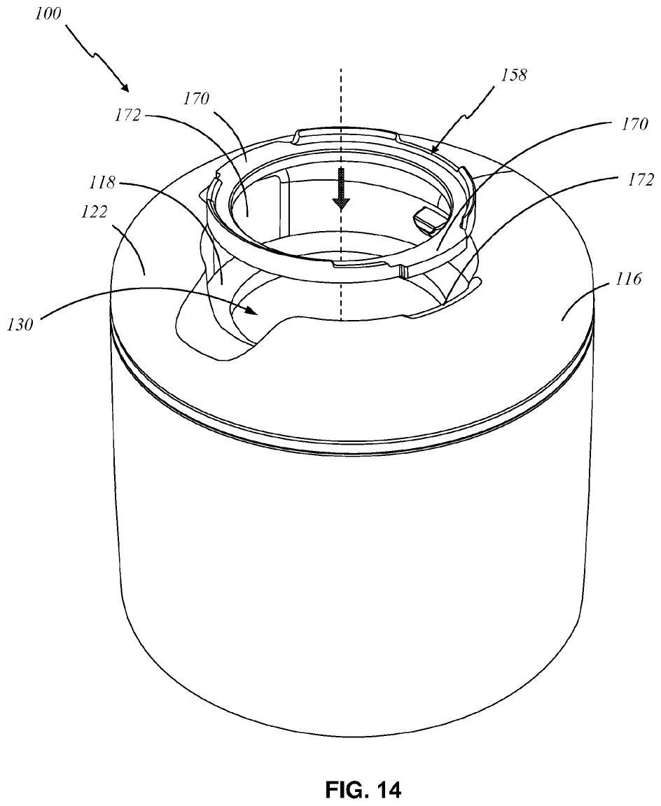

As shown in FIG. 8, the inner rim 118 includes a circumferentially extending ledge surface 126 projecting laterally from an inner periphery of the ceiling portion 122 to end at a ledge edge 128. The ledge edge 128 surrounds an aperture 130 (FIG. 14) for communication with the interior space 108 when the lid 116 is engaged with the body 102.

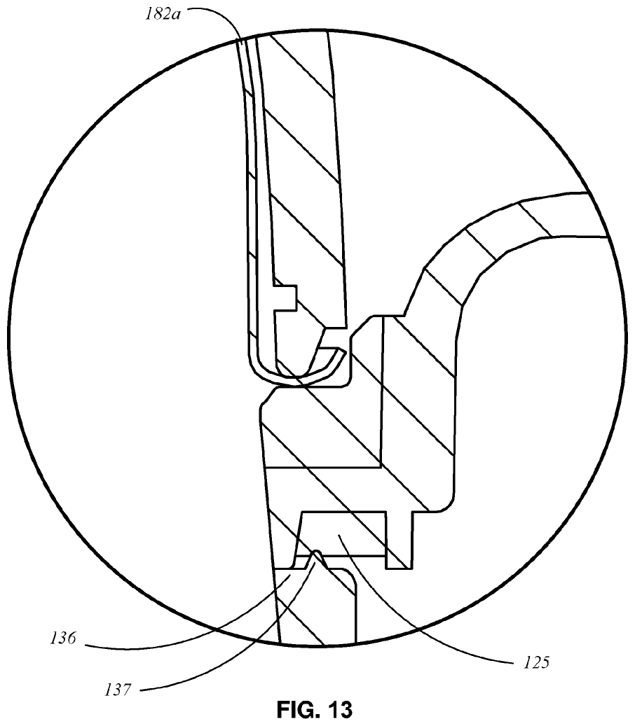

The device 100 further includes a vacuum module 132 mountable between the body 102 and the lid 116. The module 132 includes a partly annular portion 134 locatable between the inner and outer rims 118, 120 of the lid 116. The annular portion 134 has an inner diameter substantially the same as or marginally larger than a diameter of the aperture 130. The annular portion 134 is supportable at an outer periphery thereof via engagement with the resilient member 124 and the outer rim 120 of the lid 116. An inner periphery of the annular portion 134 provides a seat 136 to support the inner rim 118 of the lid 116. As shown in FIG. 13, the seat 136 has a lip 137 to engage a second resilient member 125 located beneath the inner rim 118 to sealingly connect the module 132 and the lid 116.

The module 132 further includes a housing 138 enclosing a compartment 139. In a preferred embodiment, the compartment 139 is a void. Located within the compartment 139 is a vacuum source providing a vacuum pump (not shown). The housing 138 integrally extends from the annular portion 134 and is supportable at an outer periphery thereof via engagement with the first resilient member 124 and the outer rim 120 of the lid 116.

The vacuum pump is operatively associated with a motor (not shown) and is operable to remove air from the compartment 139 and the interior space 108 to create a pressure differential between the first major face and the second major face of the coffee puck as will be discussed below.

In the depicted embodiment, the air being removed travels through a gap between the housing 138 and the sidewall 106 and into an inlet 140 to the compartment 139. The air is then pumped into the atmosphere through an outlet 142 located laterally in the ceiling portion 122 above the outer rim 120 of the lid 116. In this way, the outlet 142 is primarily positioned so that ingress of water (and/or other contaminants such as liquid or coffee puck residue) into the compartment 139 is minimised as the user removes the coffee puck from the portafilter 180, 182, 184 and/or when the user cleans the device 100. The outlet 142 is also positioned to direct exhaust away from the user. The vacuum pump is operable by way of a power source (not shown), such as batteries, housed in the compartment 139.

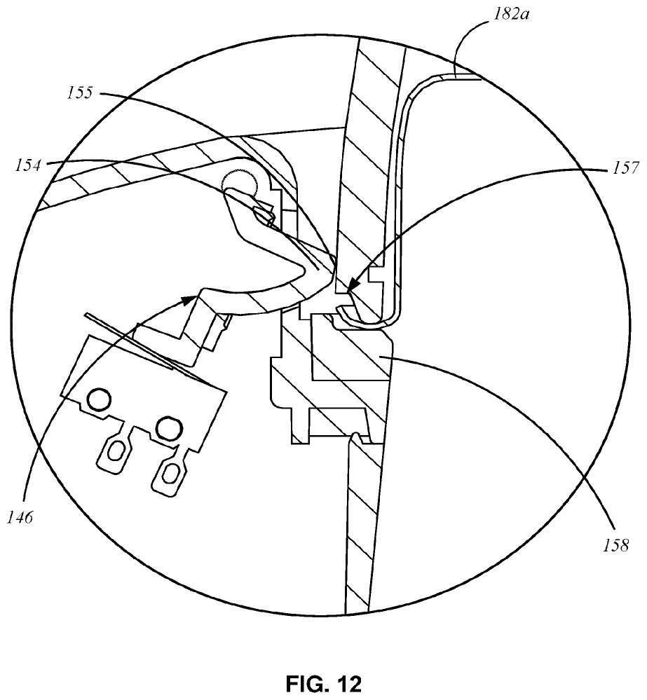

A drive signal to operate the motor is generated in response to triggering of a switch 144 located within the compartment 139. The switch 144 is triggered by an actuator 146 pivotably mounted within the compartment 139 via a pivot 148. The pivot 148 provides a pivot axis for angular rotation of the actuator 146 between an active position (see FIGS. 10 and 12) and an inactive position (see FIG. 8). The actuator 146 has a lever arm 150 attached at one end to the pivot 148, and a leg 152 attached at the other end of the lever arm 150. The leg 152 is configured to slidably engage the switch 144 to activate the switch 144 when the actuator 146 is in the active position. Connected between the lever arm 150 and the leg 152 is an elbow 154 that protrudes through a hole 156 (see FIG. 10) formed through the ceiling portion 122 of the lid 116 when the actuator 146 is in the inactive position. The actuator 146 is under bias of a spring (not shown) which urges the actuator 146 to move from the active position to the inactive position thereby urging the elbow 154 to protrude through the hole 156.

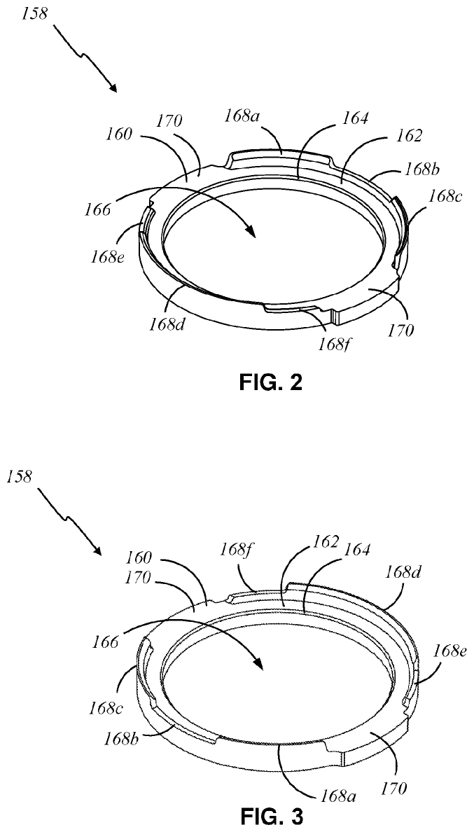

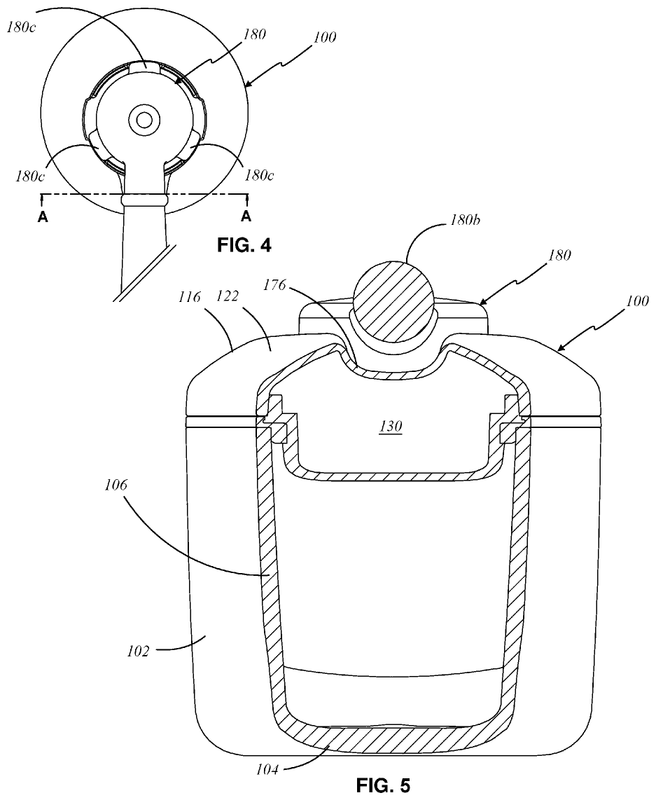

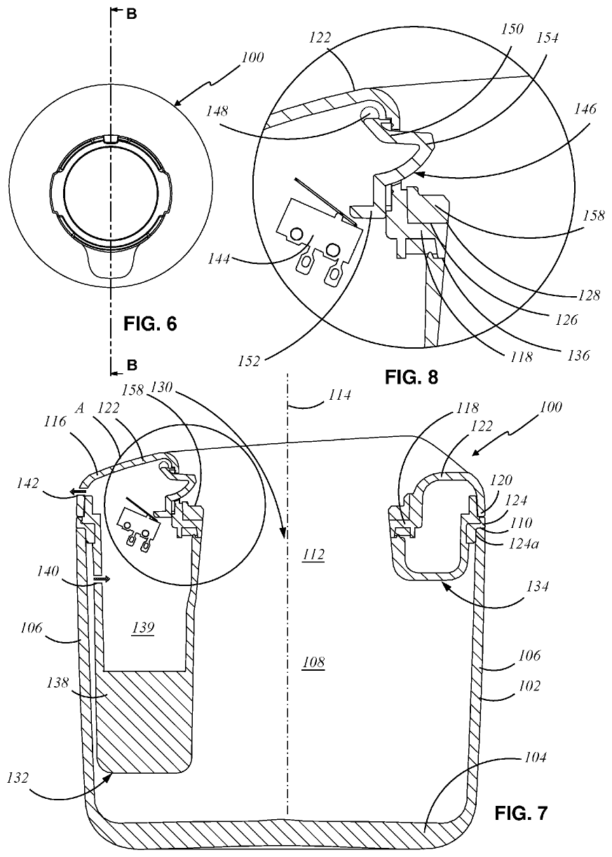

The device 100 further includes a sealing member 158 to sealingly connect the portafilter 180, 182 and the inner rim 118. With particular reference to FIGS. 2 and 3, the sealing member 158 includes a disc-shaped base 160 providing an upwardly facing sealing surface 162 radially extending between an outer periphery and a circumferentially extending inner chamfered edge 164 of the base 160. The chamfered edge 164 surrounds an opening 166 of the base 160 having a diameter substantially the same as or marginally smaller than the diameter of the aperture 130. The sealing member has an outer diameter or a maximum width dimension substantially the same as a maximum diameter of the ledge surface 126 of the inner rim 118. In this way, the sealing member 158 is configured to be concentrically seated on the inner rim 118 of the lid 116.

Upwardly projecting from the outer periphery of the base 160 is a plurality of supporting wall segments 168a-168f which vary in height and degree of circumferential extension. In the embodiment depicted, the wall segments 168a-168f include a pair of tall and narrow segments 168a, 168c separated by a short and narrow segment 168b, and a tall and wide segment 168d flanked by a pair of short and narrower segments 168e, 168f.

The plurality of supporting wall segments 168a-168f together with the sealing surface 162 and the inner chamfered edge 164 provide a sealing contact area such that the sealing member 158 is able to sealingly engage the respective portafilter 180, 182 at predefined locations on the sealing contact area based on the respective type of portafilter.

As shown in FIG. 14, the sealing member 158 also includes a pair of opposing tabs 170 to be guided by complementary indents 172 formed along an outer surface of the ceiling portion 122 of the lid 116 as the sealing member 158 is axially lowered onto the inner rim 118 to aid in locating the sealing member 158 with respect to the aperture 130. The indents 172 further serve to guide and locate the tabs 180c, 184c of the portafilter 180, 184 as the portafilter 180, 184 is positioned with respect to the aperture 130.

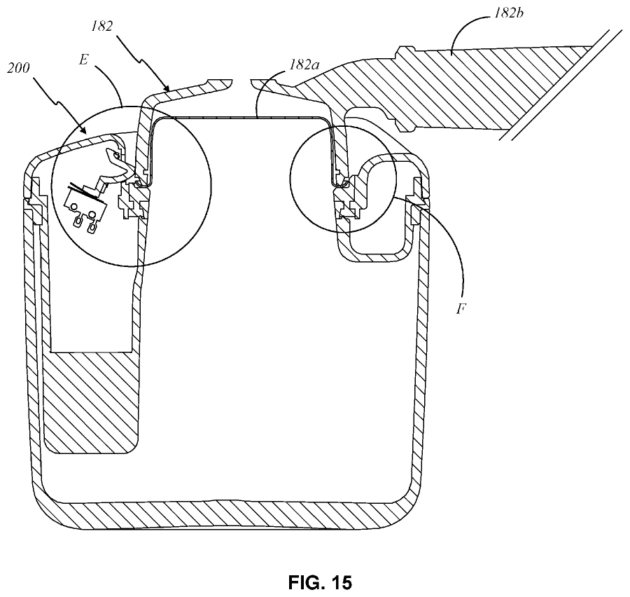

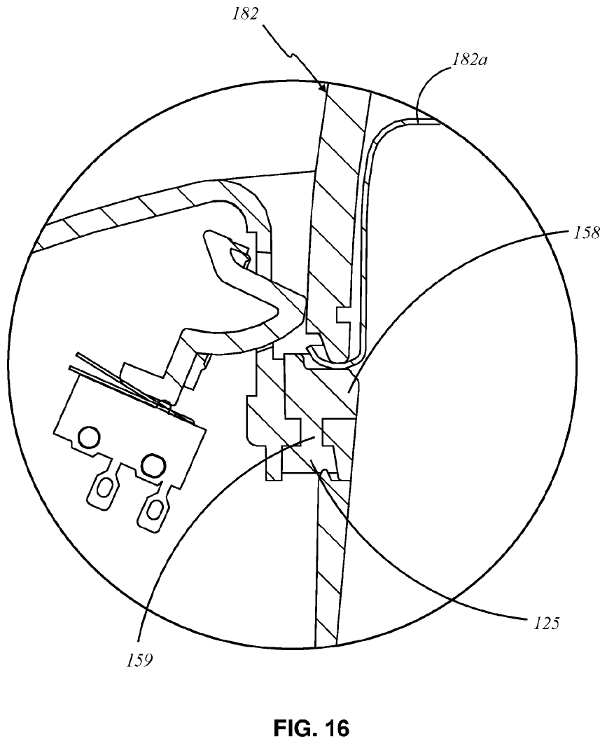

FIGS. 15 to 19 illustrate a device 200 according to a second embodiment. The device 200 is identical in construction to the device 100 of the first embodiment except that the sealing member 158 is integrally formed with the second resilient member 125 via a bridge portion 159 (see FIG. 16).

Operation of the device 100 will now be described.

The coffee puck is formed in the basket 180a, 182a of the respective portafilter 180, 182 following the coffee brewing process. The respective portafilter 180, 182 containing the coffee puck is inverted and positioned on the device 100, 200 such that the sealing member 158 engages the respective portafilter 180, 182 with the coffee puck covering the aperture 130. Engagement of the portafilter 180, 182 with the sealing surface 162 of the sealing member 158 inhibits air passing between the respective portafilter 180, 182 and the inner rim 118.

With particular reference to FIGS. 1 and 5, positioning of the respective portafilter 180, 182 with respect to the aperture 130 is facilitated by a ramp portion 174 formed along the outer surface of the ceiling portion 122 of the lid 116. If a user tends to rotate the portafilter 180, 182 to an undesired position, a ramp surface 176 of the ramp portion 174 causes the handle 180b, 182b of the portafilter 180, 182 to lift from the lid 116 which in turn causes the portafilter 180, 182 to separate from the sealing member 158.

As the portafilter 180, 182 is lowered into engagement with the sealing member 158, a portion of the portafilter 180, 182 strikes the elbow 154 of the actuator 146 causing movement of the actuator 146 against the bias of the spring from the inactive position to the active position. As shown in FIG. 12, the elbow 154 has an elongated flat portion 155 that is sized larger than a gap 157 between the basket 182a and compartment of the portafilter 182 to avoid the actuator 146 being caught by the portafilter 182 as the portafilter 182 is lowered onto the sealing member 158.

Once the portafilter 180, 182 is fully engaged with the sealing member 158, the actuator 146 is held in the active position by virtue of the elbow 154 bearing against the portion of the portafilter 180, 182. Consequently, the leg 152 of the actuator 146 engages the switch 144 to trigger the switch 144 to send a drive signal to operate the vacuum pump. The vacuum pump removes air from the aperture 130 and the interior space 108 so that air pressure applied to the exposed first major face of the coffee puck is less than air pressure applied to the second major face of the coffee puck in contact with the basket 180a, 182a, thereby causing removal of the coffee puck from the portafilter 180, 182. It would therefore be appreciated by a person skilled in the art that a vacuum or suction force is effectively acting upon the exposed major face to dislodge the coffee puck from the portafilter 180, 182.

The vacuum pump is operable to drop the pressure in the interior space 108 in a range of between about −1 kPa to −80 kPa. It is envisaged that any negative pressure within this range will be sufficient to dislodge the coffee puck. The exact negative pressure at which the coffee puck is dislodged depends on the level of compaction of the coffee puck in the portafilter, the moisture content of the coffee puck, the texture finish of the inner surface of the basket 180a, 182a, 183a, 184a, and the amount of time that the coffee puck has been in the portafilter. In some circumstances whereby the coffee puck is almost ready to be dislodged without any assistance, the required negative pressure may be even more gentle than −1 kPa.

Once the coffee puck is dislodged/removed, pressure equilibrium is achieved. The portafilter 180, 182 may then be readily separated from the sealing member 158 as the suction force is no longer acting on the portafilter 180, 182. As the portion of the portafilter 180, 182 clears the elbow 154, the actuator 146 is returned to the inactive position under the bias of the spring thereby disabling operation of the vacuum pump.

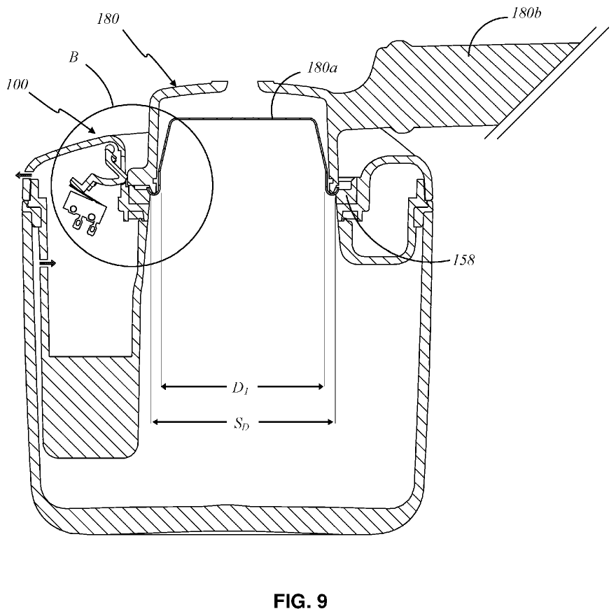

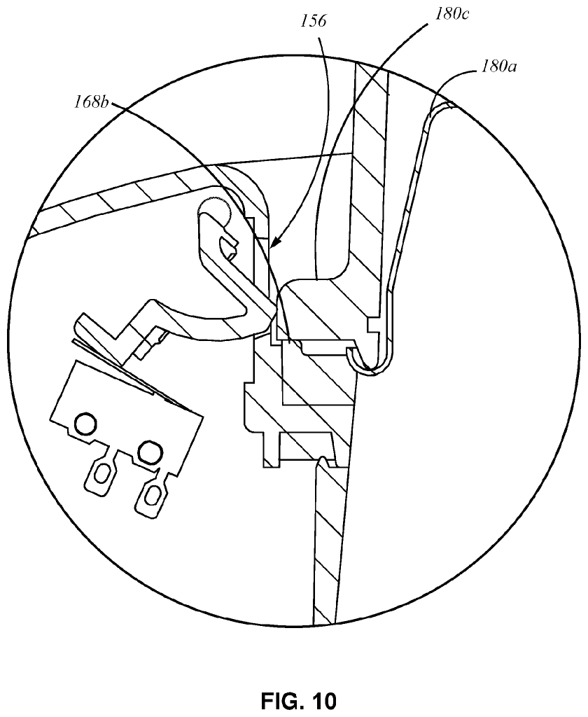

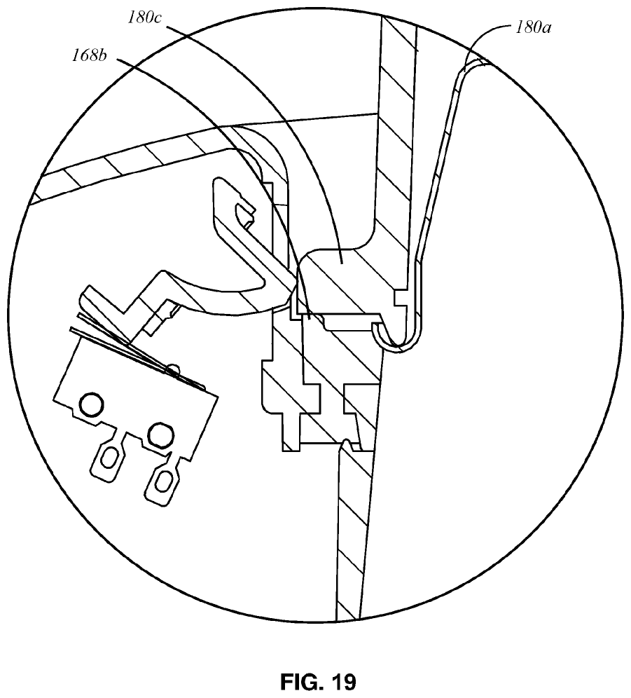

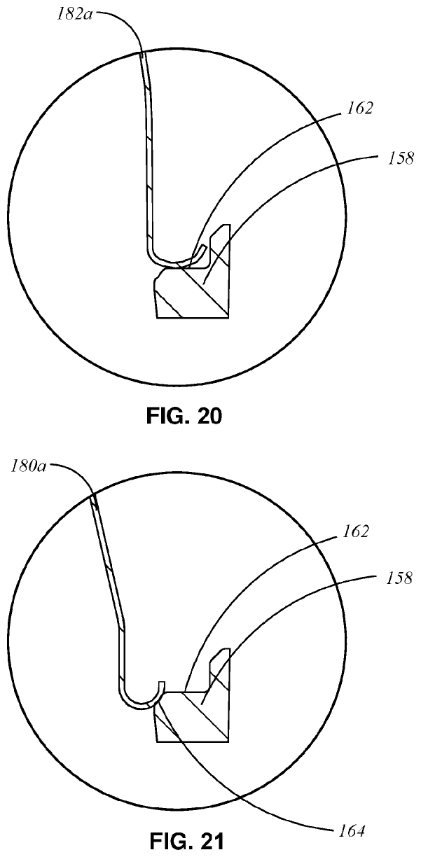

FIGS. 9 and 11 illustrate the sealing member 158 sealingly engaged with different types of portafilters 180, 182. As shown in FIGS. 11 and 20, for a portafilter 182 having a basket 182a with an opening diameter D₂ marginally less than the inner diameter S_{D} of the sealing member 158, the sealing member 158 is configured to sealingly engage the portafilter 182 via the sealing surface 162.

In contrast, as shown in FIGS. 9, 19 and 21, for a portafilter 180 having a basket 180a with an opening diameter D₁ less than the diameter D₂ of the basket 182a, the sealing member 158 is configured to sealingly engage the portafilter 180 via the inner chamfered edge 164, with the wall segments 168b, 168e, 168f supporting corresponding tabs 180c of the portafilter 180.

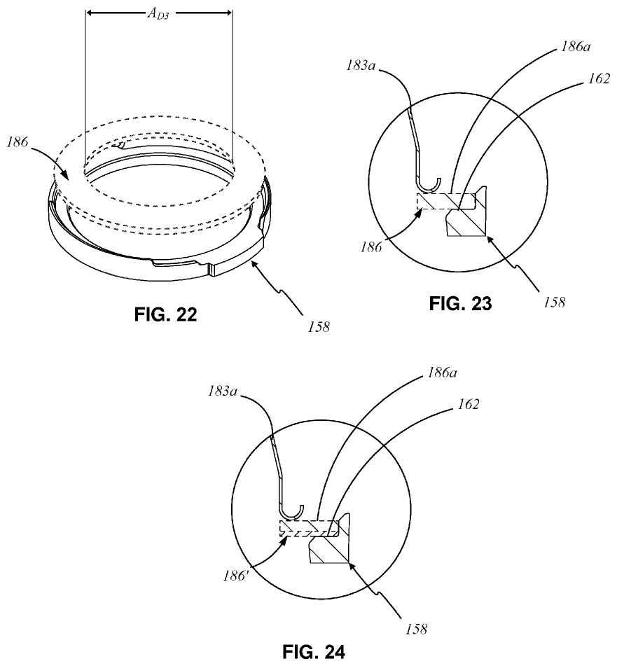

With particular reference to FIGS. 22 and 23, the device 100 optionally includes a first adaptor ring 186 for use with a portafilter having a basket 183a with an opening diameter less than the diameter D₁ of the basket 180a. The adaptor ring 186 has an outer diameter greater than the inner diameter S_{D} of the sealing member 158, and an inner diameter A_{D3} the same as or marginally greater than the diameter of the basket 183a. During use, the adaptor ring 186 is configured for sealing engagement with the sealing surface 162 to effectively enlarge the sealing contact area. In this instance, an upper surface 186a of the adaptor ring 186 is configured to sealingly engage the basket 183a of the portafilter. The adaptor ring 186 has a nominal thickness or height sufficient to support the portafilter on the sealing member 158.

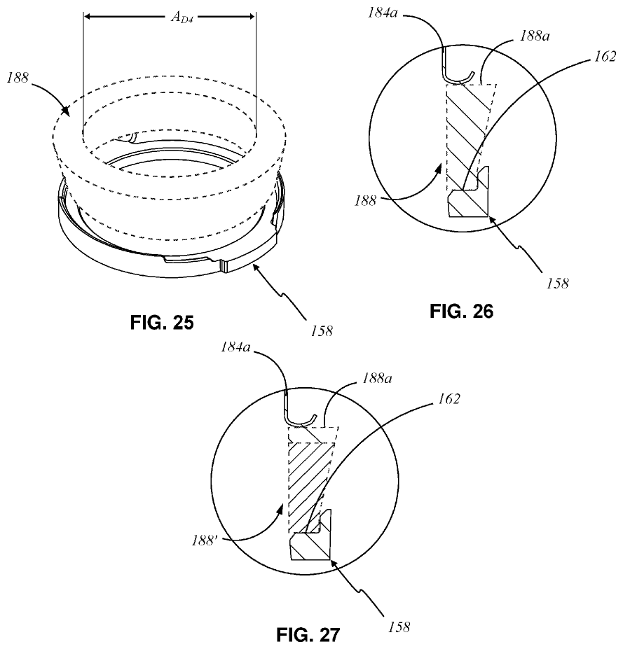

With particular reference to FIGS. 25 and 26, the device 100 optionally includes a second adaptor ring 188 for use with a portafilter 184 having a basket 184a with an opening diameter greater than the diameter D₂ of the basket 182a and/or for use with a portafilter 184 in which the ceiling portion 122 obstructs the tabs 184c of the portafilter 184. The second adaptor ring 188 has an inner diameter A_{D4} the same as or marginally greater than the diameter of the basket 184a. The second adaptor ring 188 has a generally trapezoidal cross-section with a height sufficient to clear a height of the ceiling portion 122 to prevent interference between the tabs 184c of the portafilter 184 and the lid 116. During use, the second adaptor ring 188 is configured for sealing engagement with the sealing surface 162 to effectively transpose the sealing contact area to a height above the ceiling portion 122. Like the first adaptor ring 186, an upper surface 188a of the second adaptor ring 188 is configured to sealingly engage the basket 184a of the portafilter 184.

The inner diameter S_{D} of the sealing member 158 is configured to be greater than or marginally greater than each of the opening diameters of each of the baskets 180a, 182a, 183a, 184a to permit the coffee puck to fall through the sealing member 158 relatively unobstructed.

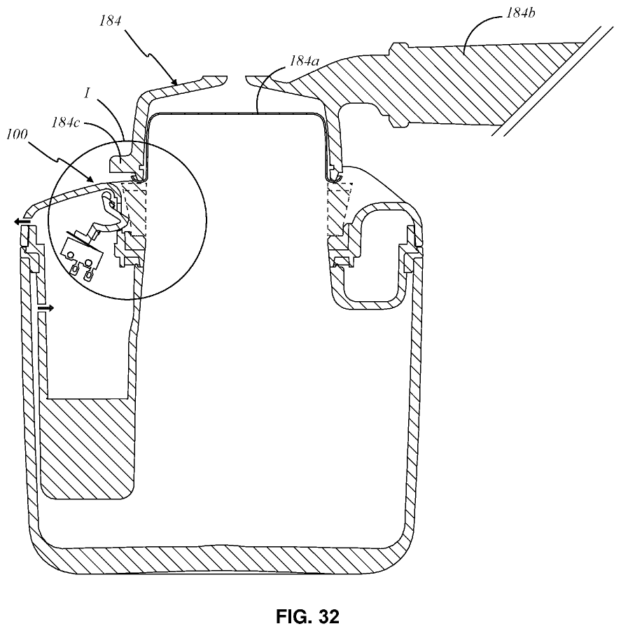

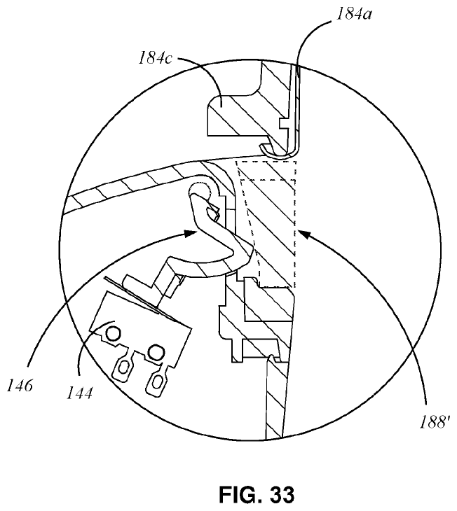

As shown in FIGS. 24 and 27, the first and the second adaptor rings 186′, 188′ may be divided into an upper portion and a lower portion. The upper portion is made from elastic material (e.g. silicone) to achieve a better sealing and the lower portion is made from more rigid material to ensure a better degree of contact between the adaptor ring 186′ and the sealing member 158. FIGS. 32 and 33 illustrate how the switch 144 is activated via engagement between the actuator 146 and the second adaptor ring 188′.

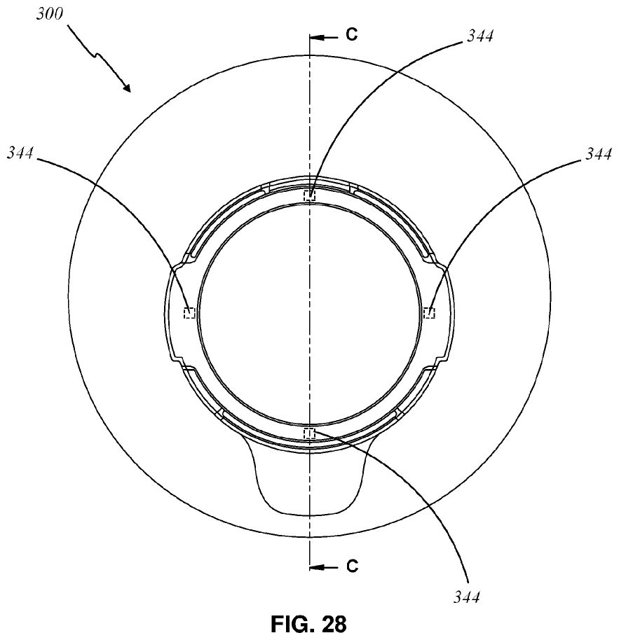

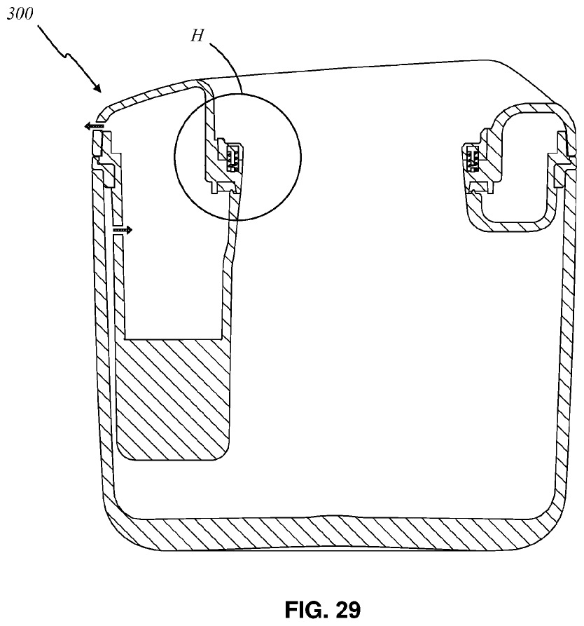

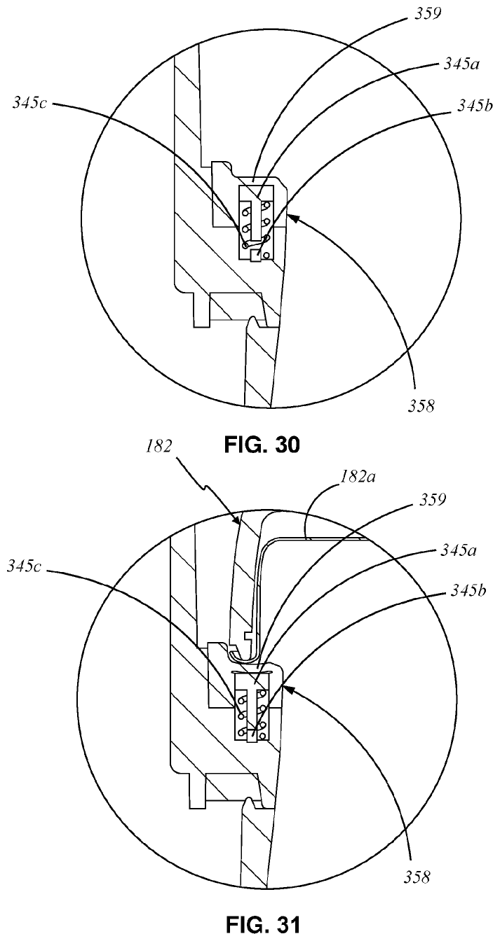

FIGS. 28 to 31 illustrate a device 300 according to a third embodiment. The device is similar in construction to the device 100 of the first embodiment except that the device 300 includes at least one switch 344 operatively associated with the sealing member 358. In the embodiment depicted, there are four switches 344. Like the switch 144, triggering of the switches 344 operates the vacuum pump. Each of the switches 344 has a pin 345a to contact a base 345b to complete a circuit of the switch 344 thereby activating the switch 344. The pin 345a is under bias of a spring 345c which urges the pin 345a to move away from the base 345b to an inactive position. The pin 345a is engaged with a portion 359 of the sealing member 358 such that sealing engagement between an appropriately sized basket 182a of the portafilter 182 and the sealing member 358 causes local deformation of the portion 359 of the sealing member 358 which causes the pin 345a to move against the bias of the spring 345c to contact the base 345b thereby activating the switch 344. The number of the activated switches 344 indicates the level of contact between the portafilter 180, 182 and the sealing member 358. For example, the portafilter 180, 182 sealingly contacts with the sealing member 358 if all the switches 344 are activated. The contact between the portafilter 180, 182 and the sealing member 358 is not optimal (sealed) if only one or two of the switches 344 are activated. Each switch 344 may provide feedback to the user indicating a need to adjust the position of the portafilter 180, 182 and/or the sealing member 358 to ensure an optimal contact. The vacuum module 132 may only be activated if the portafilter 180, 182 sealingly contacts with the sealing member 358 (i.e. all of the switches 344 are activated).

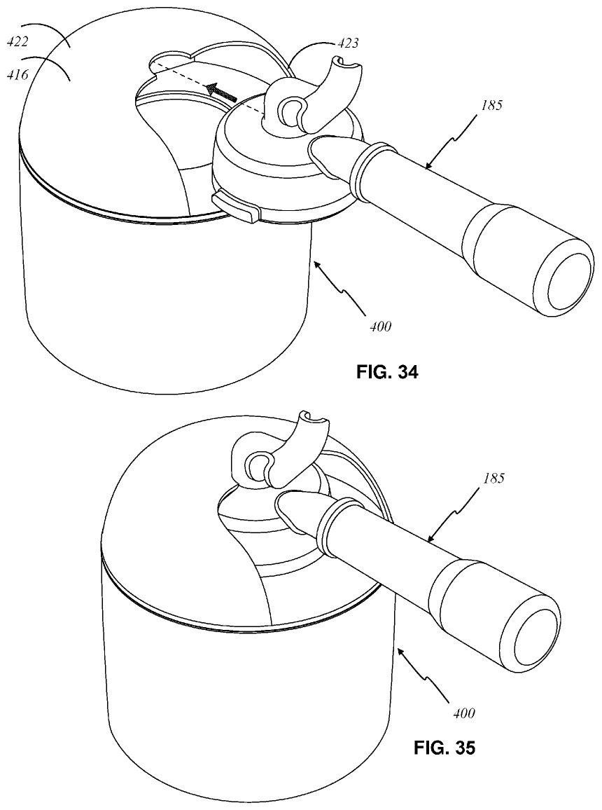

FIGS. 34 and 35 illustrate a device 400 according to a fourth embodiment. The device 400 is of a similar construction to the device 100 of the first embodiment except that the device 400 includes a lid 416 with a partially domed cap 422. The cap 422 has a cut-out 423 to slidingly receive the portafilter 185 in a horizontal or sideways insertion manner for activating a switch of the device 400.

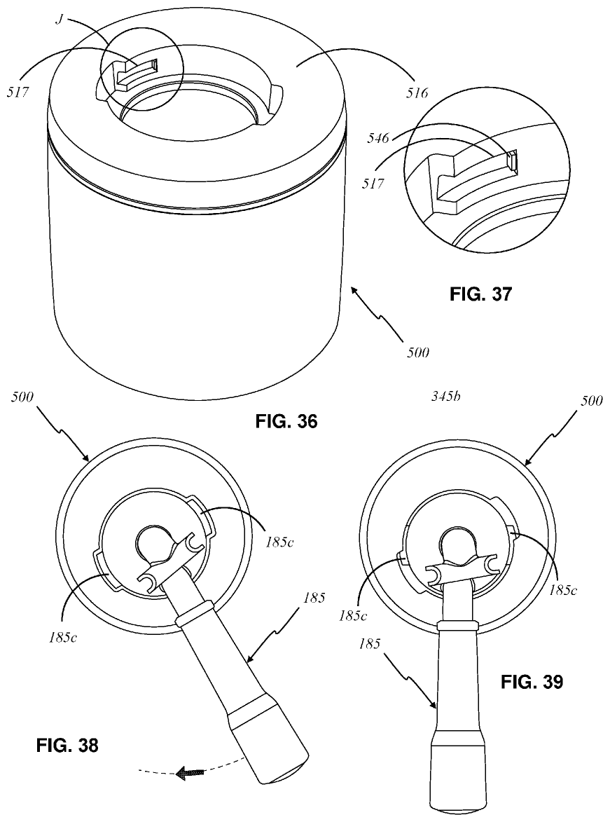

FIGS. 36 to 39 illustrate a device 500 according to a fifth embodiment. The device 500 is of a similar construction to the device 100 of the first embodiment except that the device 500 includes a lid 516 having a pair of opposing slots 517 for engaging the tabs 185c of the portafilter 185 in a bayonet-like manner to secure the portafilter 185 to the device 500. The portafilter 185 is rotated in a clockwise manner from an unlocked position to a locked position. In the locked position, the tabs 185c of the portafilter respectively engage an actuator 546 at an end of the slot 517 to enable operation of the vacuum pump.

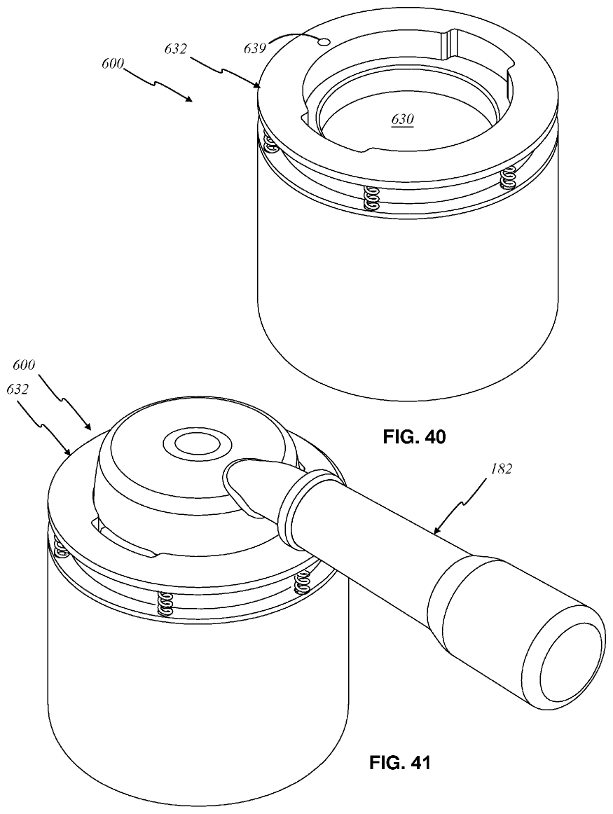

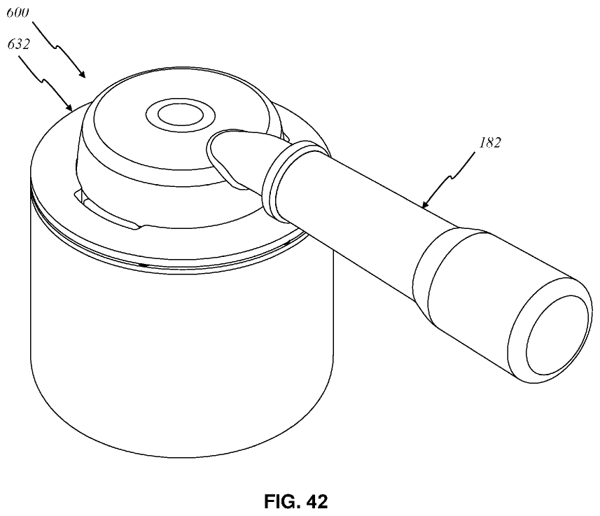

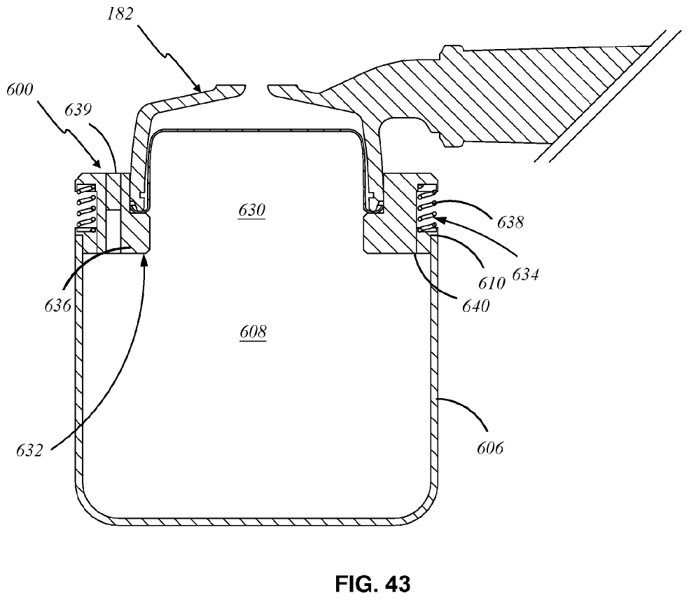

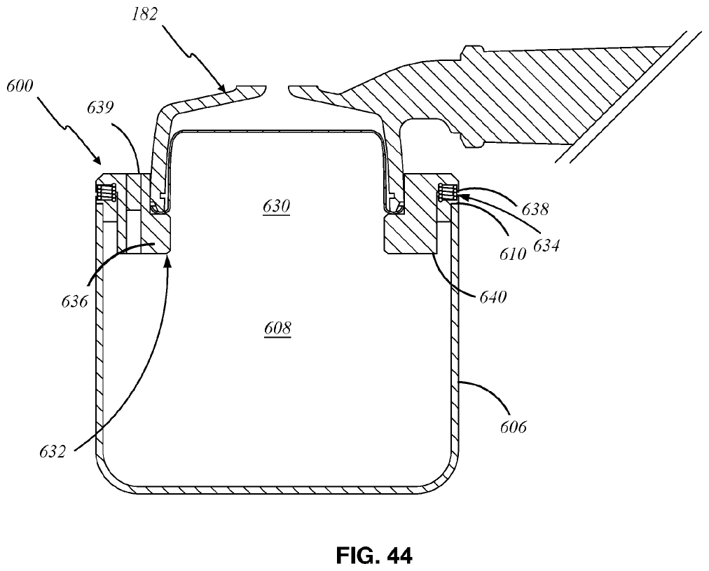

In FIGS. 40 to 44, there is schematically depicted a further embodiment of a device 600. The device 600 operates in generally the same manner as the device 100 described above. However, in this embodiment, the device 600 includes a manually-operated vacuum module 632 (instead of the electronically-operated vacuum module 132). In the depicted embodiment, and as best shown in FIG. 42, the mechanism 632 includes a bellow-like arrangement 634 extending from the upper edge 610 of the sidewall 606. The arrangement 634 has a generally hollow cylindrical body 636 which reciprocates in and out of the interior space 608 via compression of a plurality of springs 638 acting between a periphery of the body 636 and the upper edge 610. A lower end portion 640 of the body 636 is sealingly engaged with the upper edge 610.

Similar to the operation of the device 100 described above, the portafilter 182 containing the coffee puck is placed on the device 600 such that the mechanism 632 engages the portafilter 182, thereby covering the aperture 630 and inhibiting air passing between the portafilter 182 and the arrangement 634. The arrangement 634 is caused to move into the interior space 608 upon application of force on the body 636 by moving the portafilter 182 in a first downward direction towards the interior space 608. Reciprocating movement of the arrangement 634 with respect to the interior space 608 creates a negative pressure in the interior space 608. Air is removed from the interior space 608 through a one-way valve opening 639 to cause the removal of the coffee puck from the portafilter 182.

In some embodiments, an indicator (not shown) may indicate a potential failure state and/or that there is no coffee puck if the pressure and/or current draw does not decrease for a certain period of time. The vacuum source may be configured to stop operating, and inform the user of the corresponding potential failure modes.

In some embodiments, there may be a series of switches/load cells (not shown) which detect whether there is optimal contact between the portafilter and the sealing member.

In some embodiments, sensors (not shown) may be arranged for audio feedback to detect that the coffee puck is removed.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

### REFERENCE NUMERAL LIST

100 Device according to a first embodiment
102 Container body
104 Base
106 Sidewall
108 Interior space
110 Upper edge of sidewall
112 Open top
114 Central axis
116 Lid
118 Inner rim
120 Outer rim
122 Ceiling portion
124 First resilient member
124a Vertical sealing face
125 Second resilient member
126 Ledge surface
128 Ledge edge
130 Aperture
132 Vacuum module
134 Annular portion
136 Seat
137 Lip
138 Housing
139 Compartment
140 Inlet
142 Outlet
144 Switch
146 Actuator
148 Pivot
150 Lever arm of actuator
152 Leg of actuator
154 Elbow
155 Flat portion
156 Hole
157 Gap
158 Sealing member
159 Bridge portion
160 Base of sealing member
162 Sealing surface
164 Chamfered edge
166 Opening
168a-f Wall segments
170 Tabs
172 Indents
174 Ramp portion
176 Ramp surface
180, 182, 184, 185 Portafilters
180a,182a,183a,184a Basket of respective portafilter
180b, 182b, 184b Handle of respective portafilter
180c, 184c, 185c Tabs of respective portafilter
186, 186′ First adaptor ring
186a Upper surface of first adaptor ring
188, 188′ Second adaptor ring
188a Upper surface of second adaptor ring
200 Device according to a second embodiment
300 Device according to a third embodiment
344 Switches
345a Pin
345b Base
345c Spring
358 Sealing member
359 Portion of sealing member
400 Device according to a fourth embodiment
416 Lid
422 Cap
423 Cut-out
500 Device according to a fifth embodiment
516 Lid
517 Opposing slots
546 Actuator
600 Device according to a sixth embodiment
606 Sidewall
608 Interior space
610 Upper edge
630 Aperture
632 Vacuum module
634 Bellow-like arrangement
636 Body
638 Springs
639 One-way valve opening
640 Lower end portion

1. A device compatible with more than one type of portafilter to remove a coffee puck contained within an open compartment of the respective portafilter, the coffee puck having an exposed first major face and a second major face in contact with the compartment, the device including:
a body providing an interior space and having a rim surrounding an aperture of the space, with the rim being configured to engage the respective portafilter such that the first major face of the coffee puck in the open compartment of the respective portafilter communicates with the aperture;
a vacuum source to create a pressure differential between the first major face and the second major face of the coffee puck; and
a sealing member to sealingly connect the respective portafilter and the rim so that air pressure applied to the first major face is less than air pressure applied to the second major face of the coffee puck to remove the coffee puck from the respective portafilter, wherein
the sealing member provides a sealing contact area, and wherein
the sealing member is configured to sealingly engage the respective portafilter at a predefined location on the sealing contact area based on the type of portafilter.

2. The device of claim 1, wherein the sealing member includes a disc-shaped base providing an upwardly facing sealing surface radially extending between an outer periphery and a circumferentially extending inner edge of the base.

3. The device of claim 2, wherein the inner edge surrounds an opening of the base, with the opening having a diameter substantially the same as or marginally smaller than a maximum width of the aperture.

4. The device of claim 3, wherein the sealing member includes a plurality of supporting wall segments projecting upwardly from the outer periphery of the base, with the plurality of supporting wall segments together with the sealing surface and the inner edge providing the sealing contact area.

5. An adaptor for a device configured to remove a coffee puck contained within an open compartment of a portafilter, the device including a body providing an interior space and having a rim surrounding an aperture of the space, with a maximum width of the open compartment of the portafilter being less than a maximum width of the aperture, the adaptor including:
a lower surface to sealingly engage the rim; and
an upper surface having a width extending beyond the rim and partially over the aperture to sealingly engage the portafilter.

6. An adaptor for a device configured to remove a coffee puck contained within an open compartment of a portafilter, the device including a body providing an interior space and having a rim surrounding an aperture of the space, with a maximum width of the open compartment of the portafilter being greater than a maximum width of the rim, the adaptor including:
a lower surface to sealingly engage the rim;
an upper surface to sealingly engage the portafilter; and
a height extending between the lower and upper surfaces to raise the upper surface above the body to space the portafilter from the body.
